(19) United States
(12) Patent Application Publication
(10) Pub. No.: US 2025/0330063 A1
(43) Pub. Date: Oct. 23, 2025

(54) FULL-HYBRID ROTARY MOTOR WITH FUEL THERMO UNITS AND GENERATOR DRIVE

(71) Applicant: Abdullah Galip YÜKSEL, Gelibolu (TR)

(72) Inventor: Abdullah Galip YÜKSEL, Gelibolu (TR)

(21) Appl. No.: 18/866,544

(22) PCT Filed: May 26, 2022
(86) PCT No.: PCT/TR2022/050275

§ 371 Date: Nov. 17, 2024

(51) Int. Cl. H02K 7/18; F02C 3/30; H02J 7/14

(52) U.S. Cl. CPC H02K 7/1823; F02C 3/30; H02J 7/14; F05D 2220/76

(57) ABSTRACT

Turbo universal fuel rotary motor with water injection E1 and thermo air/vapour pressure E2 units, installed in an electric vehicle, which is provided with fuel, water and pressurised air tanks, which are filled at service stations, and which is automatically charged, wherever parked, via its own battery, thereby reducing expensive batteries. Unit E1, formed by two cylindrical rotors rotating inside one another, which each have a blade and rotate with connected freewheels alternatingly, freely and with different rotational speeds, about an axis, wherein the disc (3) functions as a compressor (turbo). In 2 discs which are arranged behind one another and offset by 180°, for each disc, respective 2 functional 4 working chambers (A, B, C, D) are provided and an intake of air or fuel mixture is provided in turbo disc 3 (chambers E, F), as well as a compression in the pre-chamber located in the cylinder core during an injection of the fuel, further compression alternatingly in the working chambers A-D until self-ignition and simultaneous cooling water injection provides additional power, as well as evaporation with heat absorption and cooling. In order to keep the operating temperature of the retarder constant, heated circulation water is used for injecting and converted into heat occurring in the well-insulated motor chamber by a heat exchanger, and fuel consumption, minimising pollutant emissions, reduces heat loss with the cooling of Otto engines by almost 65%. Unit E2, located in the cylinder core with additional reaction cells, brings about an intake of warm air, a compression in the reaction cells 1 or 2, which are heated by heating rods, and during the injection of pressurised air at 40 bar, an explosive expansion in the working chambers C or D, and a releasing of the hot air. With the injection of H2O or liquid CO2, vapour pressure is generated and, after release of the air mixture, liquid and air are separated by a condenser, and supplied back to the closed circuits at the optimum temperature. Air in-and outlet openings are controlled by a control sleeve (13) arranged in the interior inner cylinder (3) and driven by a rotating step motor (140). The units E1 and E2 are formed next to one another and connected for advantageous operation via switchable couplings (156-159), extension shafts (84, 88), force-transmission elements (89-95, 101) with a hydraulic retarder and locked against backward rotation.

### FIELD OF APPLICATION

The present invention relates to a combination of axial turbo all-fuel rotary engine and thermal engine (optionally with steam or compressed air operating mode). Mechanical energy is converted into electrical energy by means of generators, and the wheels are driven by rim or axle gearbox generators via batteries. At the same time, the energy generated during braking is recovered. This full hybrid rotary engine can be used in technical applications wherever conventional combustion engines or drive systems are used.

### STATE OF THE ART AND CRITICISM

Numerous reciprocating piston engines are known from the state of the art with a high energy input for the engine crankshaft, with two dead centers per working stroke and an inevitably time-accurate ignition or fuel injection and exact, fixed intake or exhaust control with opening duration. Furthermore, state-of-the-art engines require rigid working strokes with the same volume, precisely prescribed working media, a prescribed temperature and load-dependent behavior. Numerous rotary engines are also known with necessarily time-accurate ignition (see e.g., US 1 367 591), but the exact intake and exhaust control or blocking against reverse rotation in particular has not yet been solved satisfactorily. The rapid spread of gasoline engines as 2- or 4-stroke engines not only led to high noise levels but also to massive climate change caused by the harmful exhaust gases. As a result, driving bans had to be introduced for diesel vehicles in the major city centers, and even the last thing to be mentioned was getting out of the car in the short term.

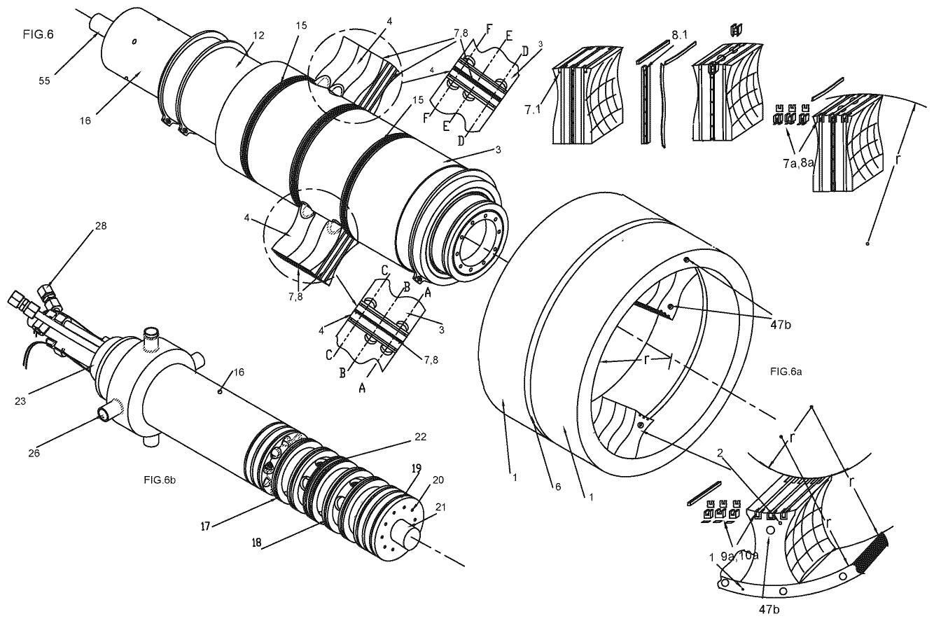

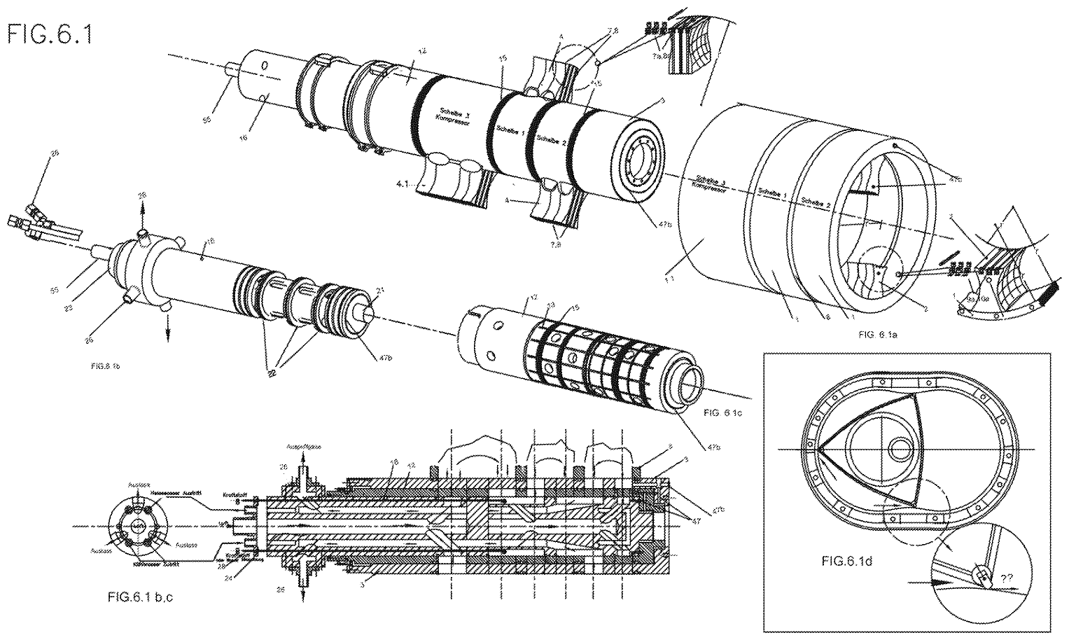

The hopeful Wankel engine was withdrawn from new car sales in Europe in 2011 due to the environmental hazards caused by the unsolvable lubrication and sealing problems, which also made it short-lived (FIG. 6.1d).

Unfortunately, hybrid vehicles, which have been used more and more in recent years, still require additional gasoline engines of the usual type.

Moreover, the charging process of expensive batteries, which have a limited lifetime of about 150-200 thousand kilometers, remains time-consuming and leads to an overload of the service networks and, as a result, to the forced use of environmentally unfriendly types of electricity. The service networks are still insufficient, and the international supply and realization are very expensive and almost impossible.

In addition, the principle of this rotary thermal engine WO2019236020, which was realized by some design changes or additions to the rotary combustion engine with the patents (WO 03/098004 A1, U.S. Pat. No. 7,156,068, DE102 23 145.1-15, and JP 4393992), does not concern the main principle.

This full hybrid system with the turbo all-fuel rotary engine and thermal engine units was combined in such a way that it only requires a hydrodynamic flow brake, which is equipped with selectable shafts that can be switched on and off by means of clutches.

### PURPOSE

This full hybrid rotary engine with the fuel and thermal unit is designed with high torque and efficiency through full energy utilization, furthermore with compressed air, steam pressure, and electric drives (efficiency approx. 95%) and can be used as an alternative to the currently existing gasoline engines (efficiency 35-40%) and hybrid & electric vehicles equipped with large, expensive batteries and charging processes that take place using environmentally unfriendly types of electricity.

### TASK

The task of this invention is also to work only with environmentally friendly generated electrical energy, which is stored with modern compressors as compressed air in depots and made available at filling stations. this technology represents one of the most cost-effective, safest and simplest methods of energy storage. The system works like a refrigeration unit with a power increase in the circuit. The greatest advantage of this system is also that excess energy can be stored in air tanks during operation, even using the vehicle's own compressors, and the battery capacity, weight and price can be kept low. Even when parked, the batteries can be quietly recharged anywhere using compressed air and steam, and the compressed air supply can also be safely supplemented by additional compressed air base stations or networks in residential areas. The turbo all-fuel rotary engine unit is fully insulated against heat loss and noise and the hot cooling water injection increases the performance by steam, prevents higher temperature, the cooling is supported by the attached cooling fins, thereby preventing the cooling energy losses of approx. 20-30% as with gasoline engines. Additional heat energy generated by the hydrodynamic water-flow brake is supplied as hot injection water.

The resulting warm air is used to heat the injection water. This design provides constant high Torg during rotation and also a suitable condition for the use of new materials such as ceramics. As a result, manufacturing costs and friction of the machine can be reduced and environmentally friendly lubricants can be used. The use of e-generators partially eliminates gear and transmission elements, allowing the recovery of braking energy with less vibration and noise.

### 6. Solution

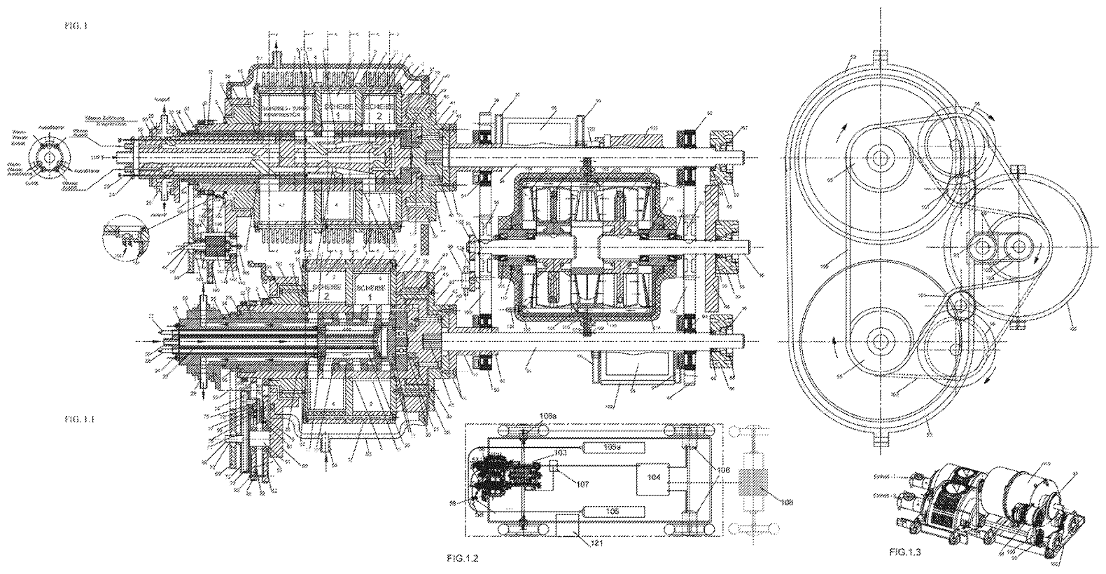

This task is solved by the objects according to patent claims 1 to 15 in conjunction with FIG. 1 to FIG. 10b. The most important innovation here is that this full hybrid engine consists of two units (called E-1- and -E2- for short), which together with a hydrodynamic flow brake=freewheels and generators.
The axial turbo all-fuel rotary engine with water injection (FIG. 1) -E1- and generator drive is characterized by two intermeshing cylindrical rotors, each of which has a blade and rotates alternately, freely and at different rotational speeds around an axis with connected freewheels, with disc 3 operating as a compressor (turbo). 2 discs arranged one behind the other and offset by 180° create 2 functional 4 working chambers (A, B, C, D) per disc. The working chambers formed between the vanes can be connected to air inlet and outlet openings, whereby the air inlet and outlet openings are controlled by a control sleeve (12) arranged in the inner cylinder (3), which is driven by a rotating stepper motor (140). The working stroke begins after self-ignition, which in turn depends on the working medium currently being used, the operating temperature and the load. working chambers or strokes and ignition always take place at any point or length during compression.
The air/steam combination (FIG. 1.1) -E2- is characterized by 4 working chambers (A, B, C, D) with a similar design and mode of operation. Initially, the warm air drawn in (working chambers A, B) is compressed in reaction cell 1 or 2 to approx. 1/18 times its original volume. /As with diesel engines, the temperature rises to approx. 700-900° Celsius and then accelerates due to the additional heating with 48 volt heating rods, which are permanently supplied by mains batteries. During the injection of compressed air at 40 bar, an explosive expansion occurs, whereby the expansion formed between the vanes continues through the connection of working chambers C or D and the hot air is then discharged.

The same happens with sudden vaporization during the injection of liquids. The working chambers formed between the vanes can be connected to 2-reaction cells, optionally (1 or 2), located in the cylinder core, air inlet and outlet openings are controlled by a control sleeve (12) arranged in the inner cylinder (3), which is driven by a rotating stepper motor (140) or Maltese cross gear (72).

The details of the invention are explained in more detail below and shown in the drawings.

FIG. 1, shows an axial turbo—all-fuel rotary engine E1—with water injection—in longitudinal section, with two cylindrical rotors rotating one inside the other, which consist of three disks arranged one behind the other and offset by 180 The engine is formed by an outer cylindrical rotor with blades and an inner cylindrical rotor with one blade per disk, whereby the turbo disk 3 acts as a compressor or starting aid for disks 1 and 2. When the engine is started, the rear rotor is held electronically or mechanically against the direction of rotation (alternatively: front-mounted generators 98 with braking effect or 97 with braking effect).) Through -E1- and -E2- with a built-in hydrodynamic flow brake against reverse rotation of outer and inner cylinder shafts 110-135, flywheel for inner cylinder opposite outer cylinder unit as mass compensation 48, inner cylinder extension shaft 84, ball bearings 85, power transmission elements such as, wide-tooth belt pulleys with magnetic couplings 90-96 and wide belts 100, drive and charging current generators 98 with electric clutches for front and rear 97, 99 and optionally switchable high-pressure compressor 103.

FIG. 1.1, shows a rotary thermal engine E2 with steam-air and generator drive in longitudinal section, consisting of two disks with inner cylinder rotor 3, which are mutually arranged, each having a vane 4 and with two outer cylinder rotor parts 1,5, 6 rotating together, each having a mutual vane 2, cylinder core with intake-outlet ducts and reaction cell carrier 16, with inner cylinders synchronously rotating 1 to 1 control sleeve 12.

FIG. 1.2, shows a schematic detail of a motor vehicle how mechanical energy is converted into electrical energy with generators and drives the wheels via batteries 107 with rims 106, 106a or axle drives 108 generators, using electronic control boxes 107, battery groups with cooling 104, high-pressure air tanks 105, H20 or C02 tank 105a, fuel tank 121, high-pressure liquid pump 29, air intake for the machine 55, heat exchanger, condenser, fan, filter system for liquid with tanks 56-58, liquid pressure indicator with sensor pulse generator 59 are used.

FIG. 1.3, shows a schematic detail of the motor perspective according to -E1- and -E2- with a built-in hydrodynamic flow brake 110.

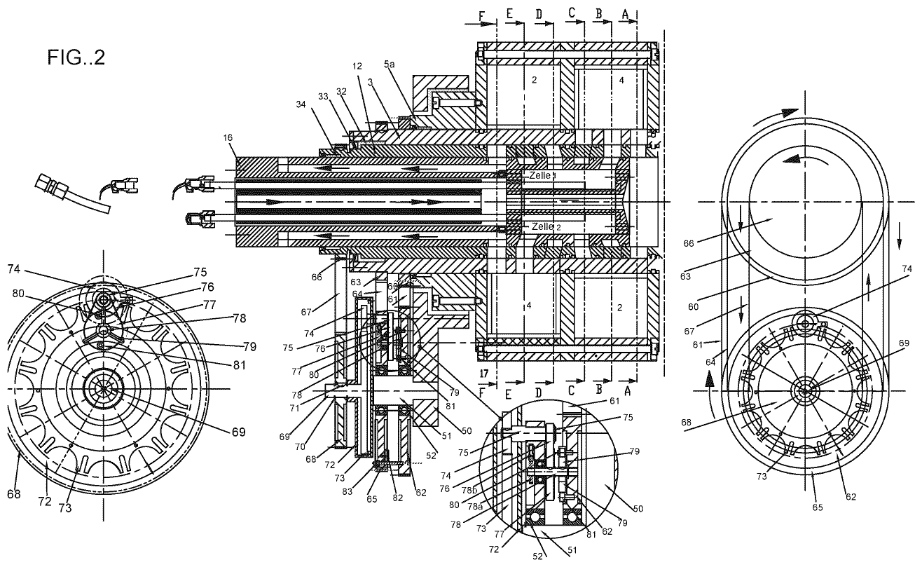

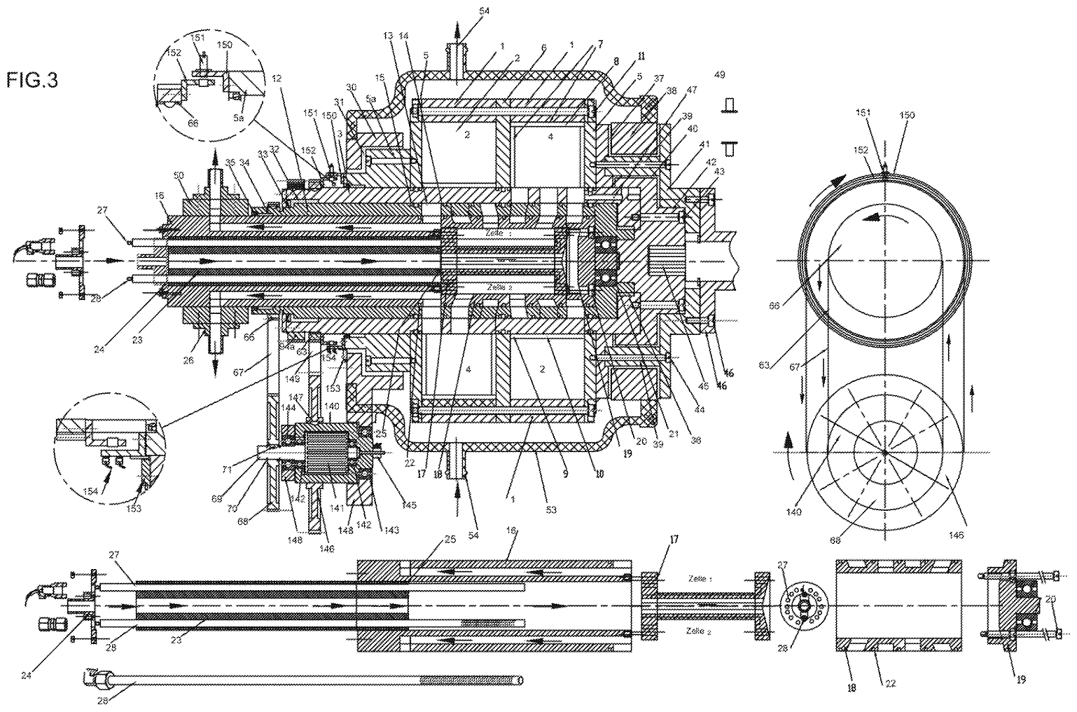

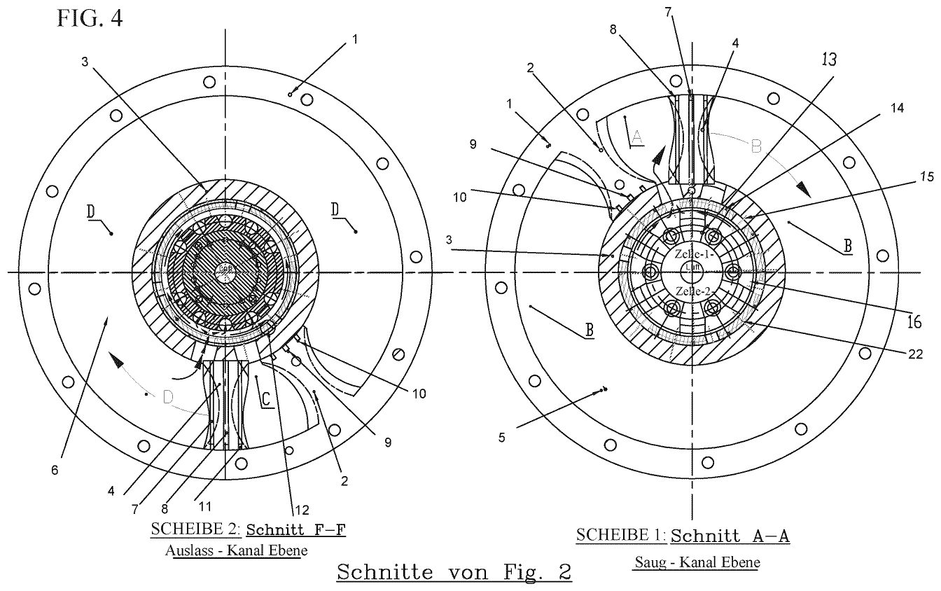

FIG. 2, shows the rotary thermal motor E2 according to FIG. 1.1 in partial longitudinal section with a Maltese cross gear 72 and the housing with the toothed belt wheel 65 as a unit, which is operated by motion elements 63,64 with the inner cylinder rotor 3 in a ratio of 1 to 1. On the opposite side of the toothed belt wheel 65, a centrally mounted toothed belt wheel 75 and the shaft 78, which is mounted with spring force 78 a, b in a restraining manner and at the other end a 3-armed leno 79 and the toothed belt wheel 75, which is connected to the toothed belt wheel 77 by toothed belts 76 in a ratio of 1 to 6 and has a balance weight 82 opposite. The toothed belt wheel 62, which is driven by the outer cylinder rotor with 61, 68 in a ratio of 1 to 1, and is equipped with limiting pins with ball bearings at the top 80, bottom 81, which rotates by 60° when it meets 79 and transmits a rotation of 6:1=to the driving pulley 74 and the Maltese cross gear wheel 73 with a rotation of 30°. This movement, which is transmitted by the toothed belt wheel 68, toothed belt 67, toothed rim wheel 66 to the co-rotating control bush 12.1:1. This controls the air inlet and outlet openings.

FIG. 3, shows the rotary thermal motor E2 according to FIG. 1.1 in partial longitudinal section as an alternative to FIG. 2, whereby the special stepper motor 140, whose housing (stator) is mounted on the drive toothed belt wheel 146, is driven by the inner cylinder rotor (3) with movement elements 63, 149 in a ratio of 1 to 1 and the necessary pulses are obtained from the mounted inner cylinder rotor dependent coding disk ring 152, electronic pulse generator surface 153, angle encoder 151, which rotates in a ratio of 1 to 1 with the inner rotor 3, the advantage lies in the electronic controllability of the air inlet and outlet opening times with the permanent flexibility. Toothed belt wheel with magnetic coupling 94a is provided for inner cylinder rotor 3 in the case of a short design of both units E1 and E2 with hydraulic brake 110.

FIG. 3a, shows the cylinder core with intake and exhaust ducts 16, reaction cells 1,2, carrier 17, reaction cell sleeve with intake and exhaust ducts 18, cover for reaction cells 19, mounting screws for cover 20, cylinder core complete with end bearing 21, complete cylinder core with sealing and oil rings and anti-rotation device 22, replaceable cartridge complete with heating rods and injection nozzles 23, mounting cover for replaceable cartridge complete with screws and gasket 24, spring-loaded sealing rings for replaceable cartridge complete 25, electric heating rods for replaceable cartridge 27, air and liquid injection nozzles 28 in detail, can be quickly replaced as a spare part if required.

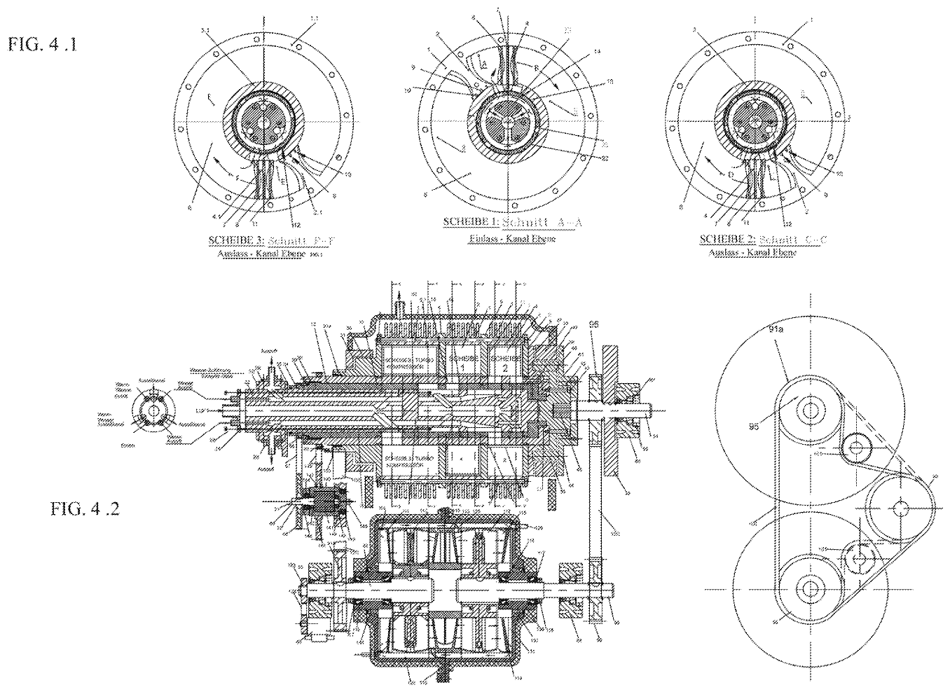

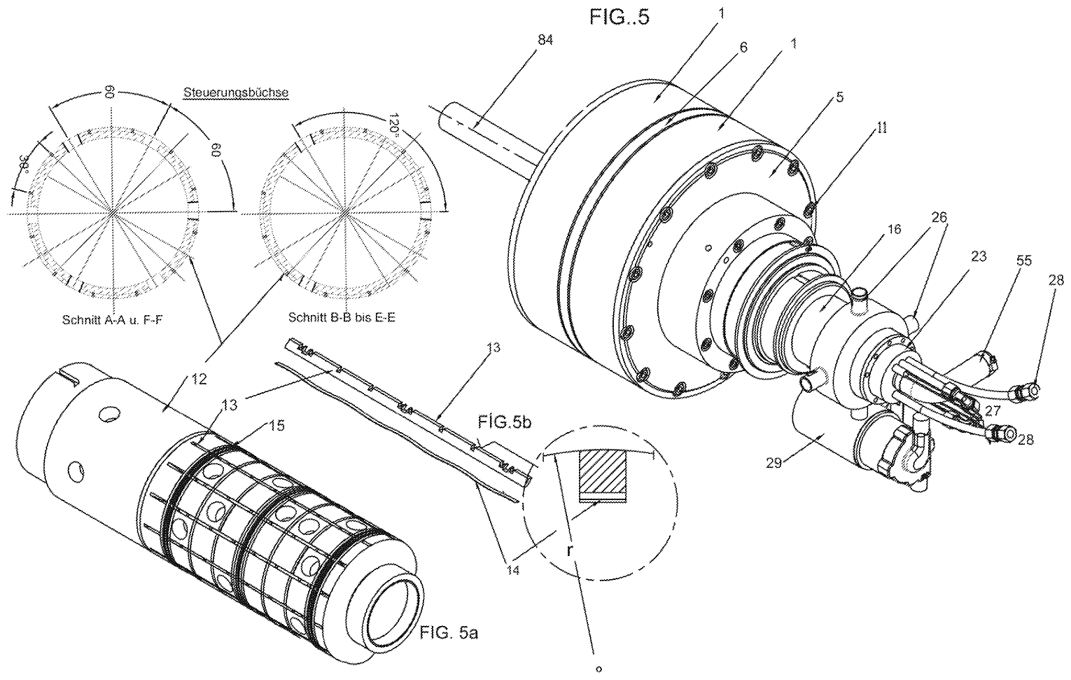

FIG. 4, shows a rotor cross-section according to FIG. 2 -E2- (section A-A) through disk 1-inlet-channel plane and (section F-F) disk 2-outlet-channel plane with functional working chambers (A, B and C, D). Cylinder core 16. Outer cylinder rotor with vanes 1 and 2, inner cylinder rotor with vanes 3 and 4, oil sealing strip with compression springs for outer cylinder vanes 9, sealing strips with compression springs for outer cylinder vanes 10, control liner 12, sealing strips, compression springs and sealing rings for control liner 13-15, cylinder core with intake and exhaust ducts with rings and reaction cells 16, 22, with suitable concave shapes for inner cylinder and outer cylinder vane surfaces for better air and gas exchange. gas exchange. If the inner rotor with vanes is made in one piece, the inner cylinder must be in two parts and bolted together for ease of assembly.

FIG. 4.1, shows a rotor cross-section of the motor according to FIG. 1. -E1- (section A-A) through disk 1-inlet-channel level-, (section C-C) disk 2-outlet-channel level-with functional working chambers (A, B and C, D) and (section F-F) with turbo-working chambers (E, F) for sucking the air or mixing and compressing in the antechamber in planned turbo-displacement ratio. Otherwise as FIG. 4.

FIG. 4.2, shows an external turbo all-fuel rotary engine -E1- design with a hydrodynamic flow brake side by side or one above the other in the short design, whereby a toothed belt wheel 91a is installed for the outer cylinder rotor.in the design-E-1+E-2- units with a hydrodynamic flow brake, a toothed belt wheel 91a with magnetic coupling is provided.

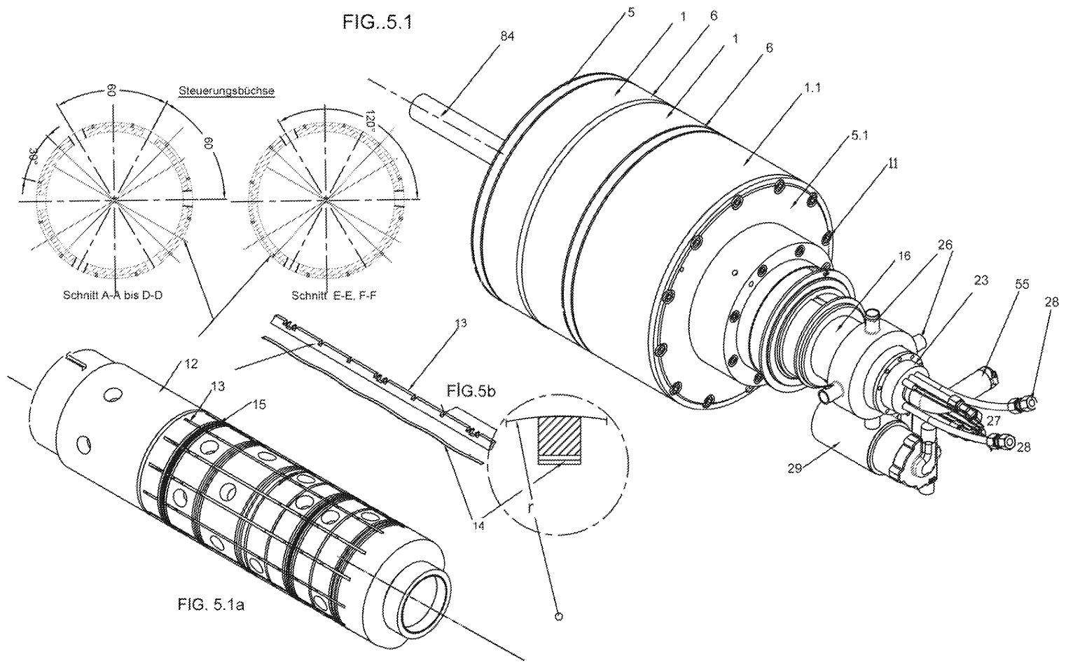

FIG. 5, shows the complete rotor perspective of the motor according to FIG. 3. -E2- , (but without control elements and insulation), outer cylinder rotor 1, disk partition 6, side walls 5, mounting bolts with nuts 11, cylinder core 16, and exhaust port 26, replaceable cartridge complete with heating rods and injection nozzles 23, 27, 28, high-pressure liquid pump 29, air intake port 55.

FIG. 5a, shows the perspective of the control sleeve 12 with inlet and outlet openings, as well as channels for the sealing strips with oil function 13 and oil sealing rings 15, end ring channel for heat-resistant seal holder 47b with oil holes 47.

The circumference of the control sleeve is divided into 12 segments, each with a spacing of 30°, whereby the suitable openings according to FIG. 2 are arranged in rows of 6 sections and in the inlet (section A-A) and outlet row (section F-F) in every second segment at an angle of 60° and offset from each other by 30°. In the other rows, there is an opening in every 4th segment.

Segment An opening at 120°. The position of the openings for the rows (section B-B and C-C) are offset by 30° in relation to row A-A, in the row (section D-D) by 60° and positioned in a clockwise direction. The row (section E-E) is identical to (section A-A).

FIG. 5b, shows perspective of the sealing strip 13 made from one piece for ease of assembly, with the ring points 15 suitably recessed, provided with oil holes and machined to the same radius as the cylinder diameter for tightness and fitted with compression spring leaves 14.

FIG. 5.1, shows the complete rotor perspective of the engine according to FIG. 1, -E1- (but without control elements and insulation), outer cylinder rotor 1, 1.1 disk partition 6, side walls 5, 5.1, mounting bolts with nuts 11, cylinder core 16, and exhaust port 26, replaceable cartridge complete with heating rods and injection nozzles 23,27,28, high-pressure liquid pump 29, air intake port 55.

FIG. 5.1a, shows the perspective of the control sleeve 12 with inlet and outlet openings, as well as channels for the sealing strips with oil function 13 and oil sealing rings 15, end ring channel for heat-resistant seal holder 47b with oil holes 47.

The circumference of the control sleeve is divided into 12 segments, each with a spacing of 30°, whereby the suitable openings according to FIG. 1 are divided into 4 rows of sections and in the inlet (section A-A) to outlet row (section F-F) there is an opening in every 4th segment. One opening is positioned at 120° in every fourth segment, but offset by 30° in relation to each other. In the turbo rows disk-3-(section E-E and F-F) in every second segment there is an opening at 60° and the position of the openings is offset by 30°.

FIG. 5.1b, shows perspective of sealing strip 13, description is as for FIG. 5b.

FIG. 6, shows rotor perspective of the motor according to FIG. 3 -E2- , inner-cylinder rotor 3, two vanes 4 arranged one behind the other and offset by 180°, each with 2 openings, the positions of the openings are, starting on the right and in the clockwise direction for the 1st row (section A-A) in front of the vane and behind it (intake), 2nd row (section B-B) front side compression, 3rd row (section C-C) rear side compression, 4th row (section D-D) rear side compression, 3rd row (section C-C) rear side compression, 4th row (section D-D) rear side compression. row (section D-D) rear side expansion=working stroke, 5th row (section E-E) front side working stroke, 6th row (section F-F) in front of the wing and behind it discharge and thus with each 30° rotation of the control box, the operations such as suction, compaction, working stroke, discharge are achieved by opening or closing the openings.

FIG. 6a, shows perspective outer cylinder rotor 1 with the opposite wing 2 and the disk partition 6.

FIG. 6b, shows perspective of cylinder core with intake and exhaust ports and reaction cell carrier complete 16-23,26,28. Air intake manifold 55.

FIG. 6.1, shows rotor perspective of the engine according to FIG. 1 -E1-, in the area of the inner cylinder rotor 3, two vanes 4 arranged one behind the other and offset by 180°, each with 2 openings. The positions of the openings are, starting on the right and in the clockwise direction for the 1st row (section A-A) in front of the vanes and behind them (intake), 2nd row (section B-B) front side compression, 3rd row (section C-C) rear side compression, 4th row (section D-D) rear side expansion =working stroke. In the area of the turbo disk inner cylinder rotor 3, 5th row (section E-E) front side suction, 6th row (section F-F) in front of the vane and behind it compression in the turbo vestibule and thus with each 30° rotation of the control sleeve, the work steps such as suction, compression in the turbo and working chamber, working stroke and discharge are achieved by opening or closing the openings, and vane details with sealing strips, springs and corner pieces 7a, 8a can also be seen.

FIG. 6.1a, shows perspective of outer cylinder rotor 1,1.1 with the opposite vane 2, 2.1 in detail with sealing strips 7a,8a,7.1,8.1 with wear as compensation, oil bore 47,a and the disk partition 6.

FIG. 6.1b, shows perspective view of cylinder core 16 with intake and exhaust ports, sealing rings 22, 23, 26, 28, air intake connection 55.

FIG. 6.1bc, shows in the area of inner cylinder rotor 3 with interfaces A-F, the cylinder core 16, control sleeve 12 with intake and exhaust ports, as well as channels and sealing rings 15 in longitudinal section-detail.

FIG. 6.1d, shows unsolvable lubrication and sealing problems of the Wankel engine in detail and in comparison.

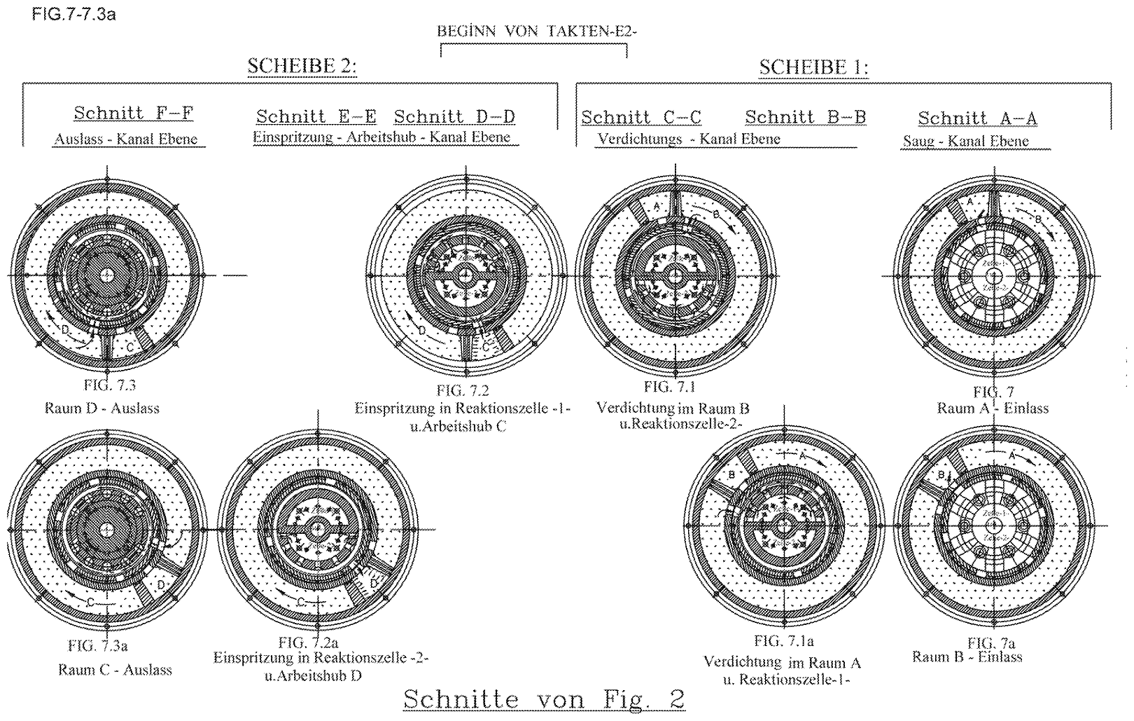

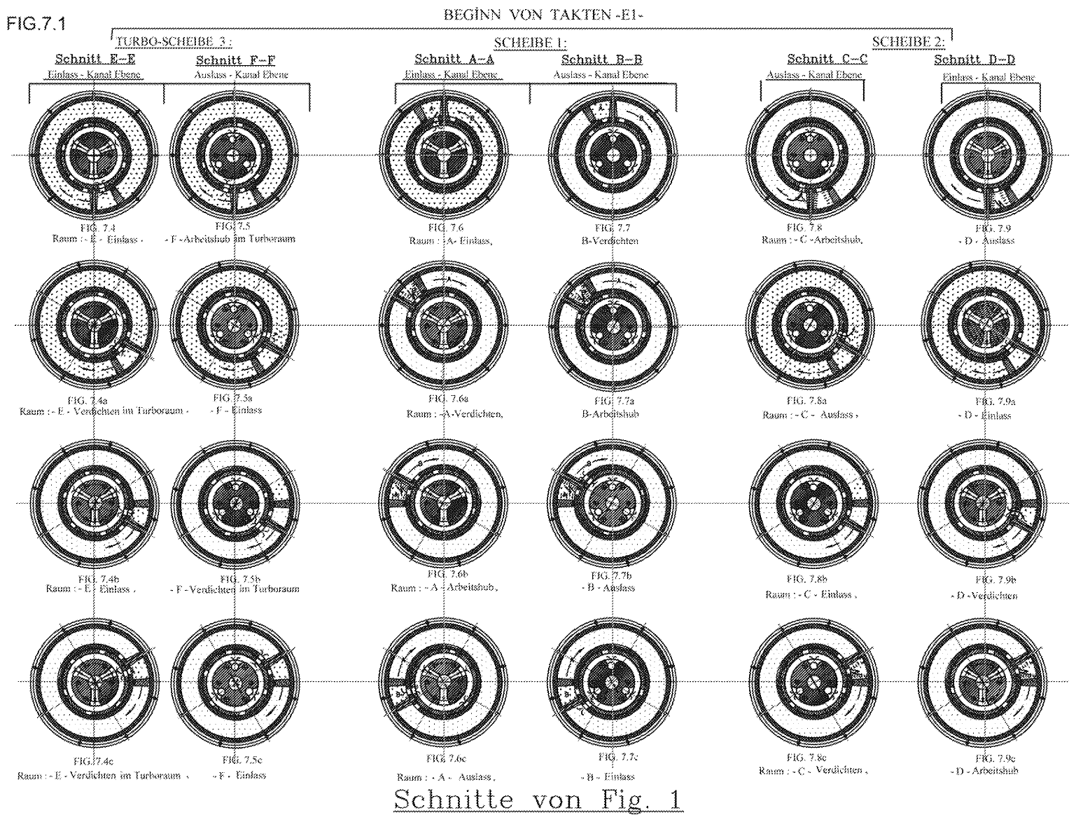

FIG. 7-7.3a, shows the different positions of the components to illustrate the operation of the engine according to FIG. 1.1 and FIG. 2. -E2- by means of 2 disk rotor cross-sections offset by 180° in the following two periods; in disk 1, A and B, in disk 2, C and D, equal to 4 working chambers and reaction cells in the cylinder core 1 and 2 in connection with them. Disk 1 (section A-A)-inlet-channel plane-‘A’-inlet, FIG. 7.1: Disk 1 (section C-C)-channel plane-compression-‘B’ and in cell 2, FIG. 7.2: Disk 2 (section D-D) injection and subsequently working stroke-‘C’ and cell, FIG. 7.3: Disk 2 (section F-F) outlet-channel plane-‘D’ outlet.in the following period: FIG. 7a: Disk 1 (section A-A)-inlet-channel level-‘B’ inlet, FIG. 7.1a: Disk 1 (section B-B)-channel level-compression-‘A’+compression in cell 1-FIG. 7.2a.Disk 2 (section E-E) injection in the sequence working stroke-‘D’ and cell2, FIG. 7.3a: Disk 2 (section F-F) outlet-channel level-'C′ outlet.

FIG. 7.1, shows the different positions of the components to illustrate the operation of the turbo engine according to FIG. 1 -E1- by means of 3 rotor cross-sections offset by 180° in the following four periods, so that all 4 strokes or 2 strokes (disk 3) take place in the working spaces “A-F” during each complete blade rotation.
Disk 1: (section A-A)-inlet-channel plane-FIGS. 7.6-7.6c, (section B-B) outlet-channel plane-FIGS. 7.7-7.7c,
Disk 2: (section C-C) outlet-channel plane-FIGS. 7.8-7.8c, (section D-D) inlet-channel plane-FIGS. 7.9-7.9c,
Turbo disk 3: Inlet duct level-(section E-E) FIGS. 7.4-7.4c, (section F-F) Outlet duct level FIGS. 7.5-7.5c

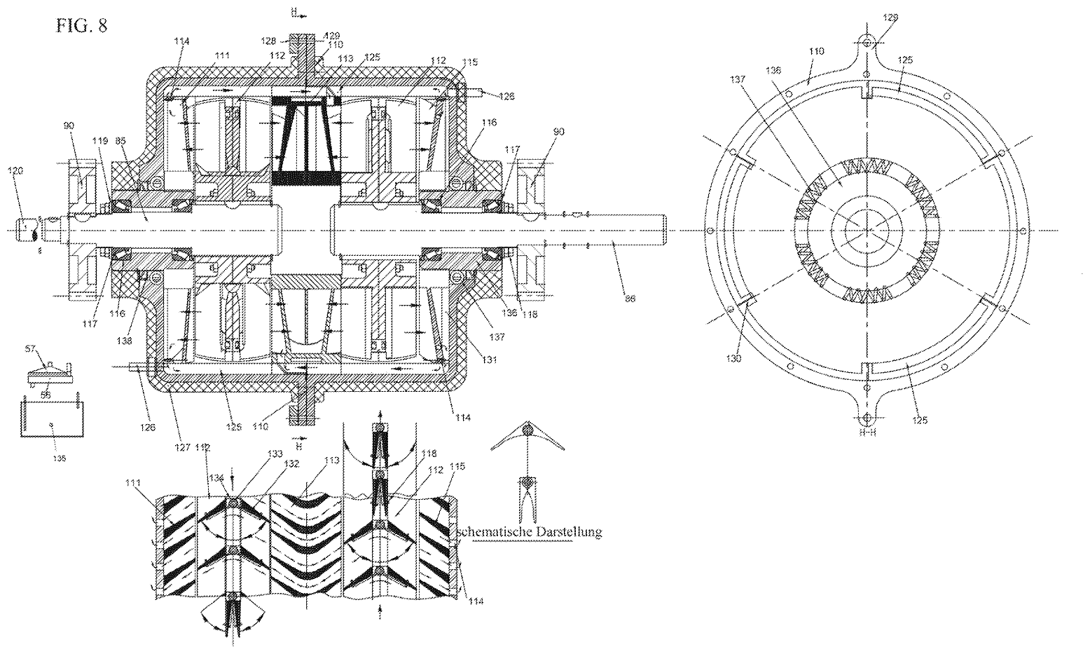

FIG. 8, shows hydrodynamic flow brake-E1, E2-with double-sided shaft flights 85, 86 consisting of two fixed housing halves 110 and with immovable vanes of outer paddle wheels left 11, right 115 and in a double-sided fixed paddle wheel with immovable vanes 113 mounted in the center with freewheel 123, which may be locked against reverse rotation. Furthermore, firmly coupled paddle wheels with movable vanes are attached to the outer and inner cylinder shafts 112, and the paddle wheels run in an oil or water, similar to an automatic transmission or a retarder flow brake.

When the respective paddle wheel rotates forwards in the liquid, the blades close and thus offer no flow resistance, while at the same time the blades of the other paddle wheel open due to the flow and spring force and brake the wheel and at the same time the deflection of the flow accelerates the opposite side of the wheel even more, which is repeated alternately with each working stroke. In order to increase the efficiency compared to the brake design mentioned in the patents (U.S. Pat. No. 7,156,068, DE102 23 145.1-15 and JP 4393992), new limiting ribs 130, openings 114 on the fixed outer blades 111, 115 and 139 on the paddle wheel with fixed blades 113 on both sides, additional limiting plates 125, additional freewheel suspension 137 as on the clutches are provided in order to achieve smoother power flows.

Heat generated by insulation shells 127 is retained and circulated through pipes 126 to heat exchanger 56 of the machine or used as injection water, whereby the thermal energy is recovered and the temperature is kept constant by sensors.

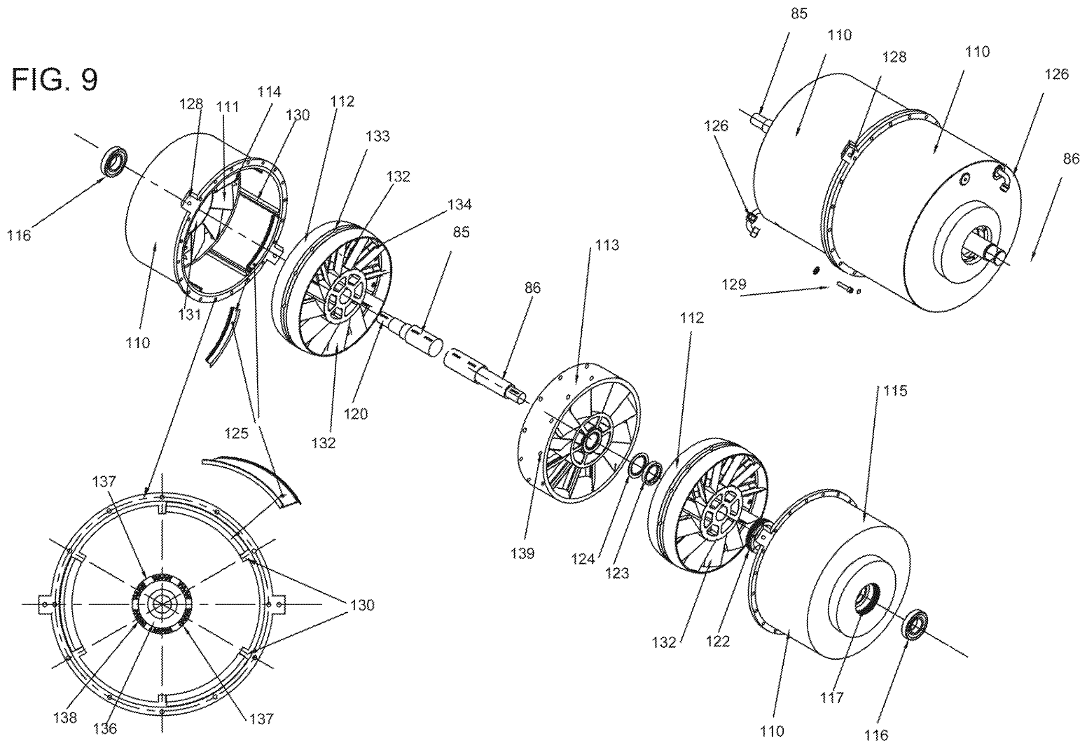

FIG. 9, shows perspective of hydrodynamic flow brake of the machine according to FIG. 8—E1, E2—consisting of identical right and left housing part 110, main base frame with support 128, fluid connection nozzle 126, freewheels 116 for Pos.110, bearing sleeve for right and left housing part 136, torsional vibration springs of movable vanes 37, sealing ring 138 for Pos.136, fixed outer vanes left and right 111,115, impellers with movable vanes 112 connected with inner and outer cylinder rotors on both sides 85,86, impeller with fixed vanes on both sides, possibly with freewheel 113, freewheel 123 for item 113, sealing rings 122 for item 110, separating ribs for fluid flow and circulation in housing part right and left 130 for item 110, openings for liquid flow 114 and circulation baffle plate for liquid 125, freewheel suspension 137.

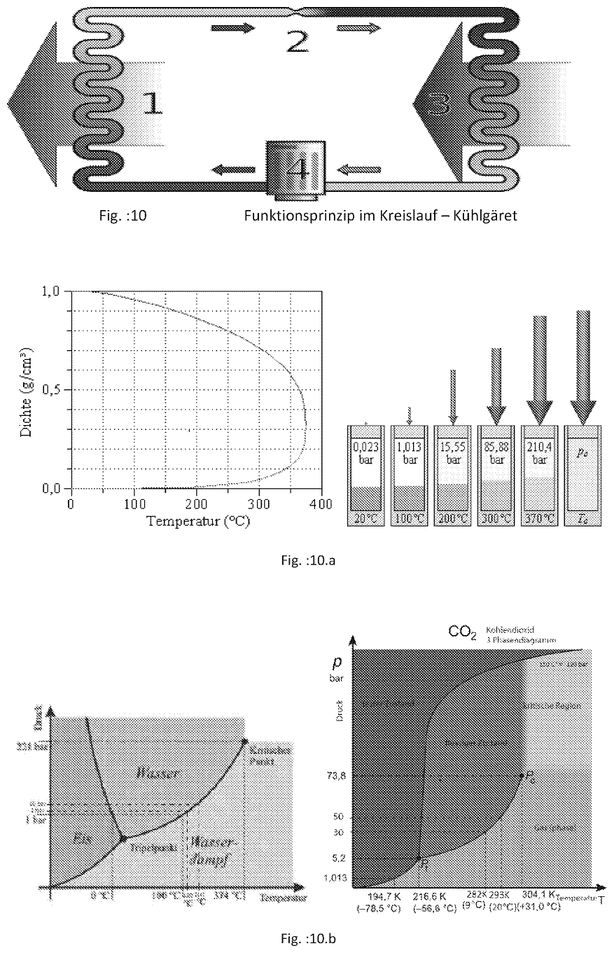

FIG. 10, shows functional principle and mode of operation of refrigerator, air conditioner and heat pump with closed circuit, where heat output can also be increased 4-fold.

FIG. 10a, shows a diagram for H2O density/temperature and a table with vapor pressure values at different temperatures. 53,127 In order to deal optimally with thermal energy, in addition to good insulation, selected working heat ranges through the control of sensors are also very important. Here are a few examples:

| Lower limit: | Upper limit: | Difference | Gain |
|---|---|---|---|
| ° C./pressure | ° C./pressure | in ° C. | in bar: |
| ~200° C./16 bar | 370° C./210 bar | 170° C. | =190 bar |
| ~120° C./2 bar | 370° C./210 bar | 250° C. | =208 bar |

FIG. 10b, shows 3-phase diagram of CO 2-carbon dioxide as an alternative, with changes of state occurring after pressure and heat.

| Lower limit: | Upper limit: | Difference | Gain |
|---|---|---|---|
| ° C./pressure | ° C./pressure | in ° C. | in bar: |
| ~9° C./30 bar | 150° C./120 bar | 141° C. | =90 bar |
| ~20° C./50 bar | 150° C./120 bar | 130° C. | =70 bar |

If 150° C. is exceeded, higher pressure values can be achieved in the supercritical range. When the cycle is released, the hot CO2/air mixture comes out and runs through a gas cooler until the values have reached ˜ 9° C.-20° C. and approx. 30-50 bar pressure, then the warm air mixture runs through a filter system, and the CO2 component becomes liquid and separates from the air, which is collected in a container to be sprayed back into the circuit. The air component is also passed on warm in the circuit to the intake manifold 55, thus starting the process all over again. In winter, the warm air can be used for heating in the vehicle. CO2 is a natural gas that has long been successfully used as a refrigerant with the designation R744 in motor vehicle air conditioning systems with a higher degree of efficiency.

### LIST OF REFERENCE SYMBOLS

1: External cylinder rotor for disk 1 and 2
1.1: External cylinder rotor for disk 3
2: Vanes for outer cylinder rotor disc 1 and 2
2.1 Wing for outer cylinder rotor disc 3
3: Inner cylinder rotor for disk 1,2
3.1: Inner cylinder rotor for disk 3
4: Wings of inner cylinder rotor for disk 1 and 2
4.1: Vane of inner cylinder rotor for disk 3
5: Outer pane walls for panes 1 and 2
5.1: Outer flange for disk 3
6: Disk partition wall outer cylinder rotor for disk 1 and 2
7: Oil sealing strip with pressure springs for inner cylinder rotor blades
7.1 Oil sealing strip with pressure springs next to each other for inner cylinder rotor blades to compensate for wear
7a: Compensation piece for wear with springs
8: Sealing strips with compression springs for inner cylinder rotor blades
8.1 Sealing strips with compression springs inside each other Inner cylinder rotor blades as compensation for wear
8a: Compensation piece for wear with springs
9: Oil sealing strip with compression springs for outer cylinder rotor blades
9a: Compensation piece for wear with springs
10: Sealing strips with compression springs for outer cylinder rotor blades
10a: Compensation piece for wear with springs
11: Mounting screws with nuts for cylinder disks and side walls complete
12: Control bushing
13: Sealing strips for control bushing
14: Spring leaf for sealing strip control bushing
15: Sealing rings with anti-rotation lock control bushing
16: Cylinder core with intake and exhaust ports or with reaction cell carrier
17: Reaction cell carrier of cylinder core
18: Reaction cell liner with intake and exhaust ports
19: Cover for reaction cell sleeve with mounting screws
20: Reaction cell carrier
21: Cylinder core complete end bearing
22: Cylinder core Komlett sealing rings+oil with anti-rotation lock
23: Replaceable cartridge complete with heating rods and injectors
24: Mounting cover for replaceable cartridge Complete with screws and gasket
25: Spring sealing rings for replaceable cartridge complete
26: Outlet pipe with screw flange with gasket
27: Electric heating rods for replaceable cartridge
28: Air and liquid injection nozzles
29: High-pressure liquid pump
30: Front main bearing cap
31: Front sintered shells for Pos:30
32: Front sintered shells for item 12
33: Sealing ring for pos.32
34: Front sintered shells for inner control bushing
35: Sealing ring for item 34
36: Rear sintered bushing bearing
37: Rear main bearing sintered shells top and bottom
38: Rear main bearing cap
39: Flange ring part for outer cylinder rotor
40: Sintered shells for inner cylinder rotor bearing
41: Flange part for outer cylinder rotor
42: Inner cylinder mounting part
43: Screws for item 42
44: Screws for pos.39
45: Plug-in connection for shaft of inner cylinder rotor
46: Flange ring for outer cylinder rotor with screws
47: Oil channel for inner cylinder rotor, control sleeve
47a: General oil holes
47b: Oil bores with heat-resistant seals or sealing rings
48: Flywheel for inner cylinder rotor
49: Oil pump with oil filter
50: Main base frame with extension holder for cylinder core
51: Main bearing shaft for drive of control bushing
52: Bearing for item 51
53: Oil tank outside
54: Insulation shell connection piece for heater
55: Air intake nozzle for the machine
56: Heat exchanger, condenser
57: Fan
58: Filter system for liquid with container
59: Liquid pressure indicator with sensor pulse generator
60: Toothed belt wheel for outside
61: Toothed belt for item 60
62: Toothed belt wheel for limiting pins
63: Toothed belt wheel for inner cylinder rotor
64: Toothed belt for items 63,65
65: Toothed belt pulley for item 72
66: Toothed belt pulley for item 12
67: Toothed belt for pos.66,68
68: Toothed belt pulley for item 69
69: Shaft of Maltese cross gear
70: Circlip for 69
71: Wedge for toothed belt pulley 68
72: Maltese cross gear housing
73: Maltese cross gear wheel
74: Driving pulley of Maltese cross gearbox
75: Driving pulley shaft and toothed belt wheel
76: Toothed belt for item 75
77: Toothed belt wheel for item 79
78: Toothed belt wheel shaft for pos.79
78a: Shaft holder for item 78
78b: Spring retainer for item 78a
79: 3-arm turners for item 75
80: Top limiting pin with ball bearing
81: Bottom limiting pin with ball bearing
82: Balancer weight belt pulley item 65
83: Sensor driver
84: Inner cylinder extension shaft for E.1 and E.2
85: Outer rotor, connecting shaft of item 110
85a: External rotor, connecting shaft of item 110 FIG. 4.2
86: Inner rotor, connecting shaft of pos. 110
87: Ball bearing for Pos.84
88: Sealing rings
89: Fastening for shaft bearing
90: Belt pulley for items 85,86
91: Toothed belt wheel with magnetic coupling for external rotor E.1
91a: Toothed belt wheel for external rotor E.1, FIG. 4.2
92: Toothed belt wheel with magnetic coupling for inner rotor E.1
92a: Toothed belt wheel with magnetic coupling for inner rotor E.1 for short combined version
93: Toothed belt pulley with magnetic coupling for outer rotor E.2
94: Toothed belt pulley with magnetic coupling inner rotor E.2
94a: Toothed belt pulley with magnetic coupling inner rotor E.2 for short combined version
95: Drive wheel for internal rotor
96: Toothed belt pulleys for power generators
97: Magnetic clutch with braking for 98
98: Power generators
99: Clutch for item 103
100: Wide toothed belt
101: Toothed belt tensioner
102: Frame for item 98
103: High pressure compressor
104: Battery group with cooling
105: High-pressure air tank
105a: H2O or C02 tank
106: Wheel rims Power generator 48 V for rear wheels
106a: Wheel rim power generator 48 V for front wheels
107: Vehicle electronic control box
108: Axle drives-generators-alternative to item 106
110: Hydrodynamic flow brake with right and left housing part
111: Fixed paddle wheel with blades on the left
112: Blade wheels with movable blades, connected to inner or outer cylinder rotor
113: Middle paddle wheel with fixed blades on both sides, possibly with freewheel
114: Openings for hidrofluid flow or circulation.
115: Fixed impeller with blades on the right
116: Bearing possibly as freewheel depending on design
117: Sealing rings for item 116
118: Adjusting nut
119: Adjusting nut Washer
120: Extension with bearing if required
121: Fuel tank
122: Sealing rings for item 110
123: Drive belt pulley
124: Belt for item 49
125: Deflector plate for flow and circulation.
126: Hidrofluid connection piece to the injection or heat exchanger
127: Insulation shell of the hydrodynamic flow brake
128: Main base frame with bracket
129: Bracket for item 110
130: Limiting ribs for hidrofluid circulation in the housing section right and left of item 110
131: Support lever for fixed sashes
132: Movable double-sided vane pairs right and left for impellers Pos.112
133: Mounting bolt for item 132
134: Spring for items 132,133
135: Hidrofluid tank and possibly with pump
136: Bearing sleeve for right and left housing part item 110
137: Torsion springs of movable sashes for items 112 and 133
138: Sealing ring for item 136
139: Openings for hidrofluid flow and circulation.
140: Stepper motor stator
141: Rotor for item 140
142: Stepper motor rear shaft bearing
143: Stepper motor rear frame bearing
144: Stepper motor frame bearing front
145: Current guide channel and brushes for item 140
146: Drive toothed belt wheel
147: Wedge for item 146
148: Underframe bearing
149: Toothed belt for items 63 and 146
150: Ring as holder and power supply for items 151, 145
151: Electronic sensor, angle encoder
152: Coding disk ring for 63
153: Electronic pulse encoder surface
154: Power supply brushes

1. A full hybrid rotary motor comprising a combination of two axial units having the same design and operation, firstly; turbo all-fuel rotary motor (abbreviated as E-1) and secondly, thermal motor (optionally with steam or compressed air operation) (abbreviated as E2), which consists of two or three disks arranged one behind the other, offset by 180° degrees, each of which has a blade, is connected alternately to a fixed housing by freewheels and rotates alternately about an axis at different speeds, can be connected to either (E-1) or (E2) in the operating mode currently in use and with the same hydraulic brake, characterized in that the motor shafts 46, 84, which are connected to electrically or mechanically shiftable clutches equipped with wide toothed belt wheels 91-94, wide belts 100 and hydraulic brake shafts 85, 86, are held against reverse rotation during operation, whereby mechanical energy is converted into electrical energy by means of generators and charged in a mains battery.

2. Fully hybrid rotary engine (E1) according to claim 1, characterized in that the rotation of the shafts results in an intake of compressed air-fuel mixture from the vestibule, an alternating compression in the working chambers A-D until auto-ignition, which in turn is dependent on the working medium currently used, the working temperature and, during the working stroke, a controlled hot water injection, which gains additional power through evaporation and saves 30% of the cooling loss of gasoline engines, during the working strokes, whereby working chambers formed between the blades with air inlet and outlet openings are controlled by a control sleeve 12 arranged in the inner cylinder 3, which is controlled by a rotating stepper motor 140.

3. Full hybrid rotary motor (E2) according to claim 1, characterized in that the rotation of the shafts results in an intake of air, a compression in the vestibule located in the cylinder core and by compressed air injection of 40 bar, to an explosive expansion between the blades (E2), a working stroke and a release of the gases or air, whereby working chambers with air inlet/outlet openings formed between the vanes are controlled by a control sleeve 12 arranged in the inner cylinder 3, which is controlled by a rotating stepper motor 140 or Maltese cross gear 72.

4. Fully hybrid rotary motor (E1) according claim 2, characterized in that the inlet and outlet openings of the control sleeve 12, the circumference of which is divided into 12 segments each with a spacing of 30° resilient sealing strips 13, 14, with inlet and outlet openings of the turbo disk 3, with inlet (section E-E) and outlet row (section F-F) in every second segment 60° and and in the other rows (section A-A) to (section D-D) which are each arranged at 120° intervals, but offset by 30° relative to one another, whereby the stepper motor 140 is controlled by a control element consisting of disks 150, 152 with an angle encoder 151, which rotates in a ratio of 1 to 1 with the inner cylinder rotor 3, whereby the resulting stepper motor stator 141 transmits rotations, cycles of 30° through movement elements 66-67 in a ratio of 1 to 1 to the control sleeve 12 and thus enables the development of an exact inlet and outlet control of the machine with complete combustion of the gases and the working cycles always take place at any length and position.

5. Fully hybrid rotary engine (E2) according to claim 3, characterized in that the inlet and outlet openings of the control sleeve 12, the circumference of which is divided into 12 segments with a spacing of 30° each by the use of resilient sealing strips 13, 14, wherein the inlet and outlet openings of the disks 1 and 2 cooperate with each other, which are each arranged at 120° intervals in 3 rows of sections per disk, wherein the inlet (section A-A) and outlet (section F-F) rows are arranged at 60° in every second segment, but offset by 30° relative to each other, and in the other rows an opening is arranged at 120° in every 4th segment. The position of the openings for the rows (section B-B and C-C) is offset by 30° in relation to row A-A, in the row (section D-D) by 60° in the clockwise direction and the row (section E-E) is identical to (section A-A).

6. Full hybrid rotary engine (E1) according to claim 4, characterized in that the inner cylinder rotor 3 of the engine, with two wings 4 arranged one behind the other and offset by 180°, each with 2 rows of openings and 2 attached openings, the position of the openings being, starting on the right and clockwise for the 1. Row (section A-A) in front of the sash and behind it (intake), 2nd row (section B-B) front side sealed, 3rd row (section C-C) rear side sealed, 4th row (section D-D) rear side sealed. Row 4 (section D-D) rear side expansion=working stroke and at the same time, in the area of the turbo disk, row 5 (section E-E) front side intake, row 6 (section F-F) in front of the vane and behind it compression in the turbo antechamber and thus with each 30° rotation of the control sleeve, the operations such as intake turbo disk 3 and working chamber, compression in the turbo disk and working chamber, working stroke, exhaust are achieved by opening or closing the openings.

7. Fully hybrid rotary engine (E2) according to claim 5, characterized in that the inner cylinder rotor 3 of the engine, with two vanes 4 arranged one behind the other and offset by 180°, each with 3 rows of openings, with 2openings on each side, starting on the right in the clockwise direction for the 1st row in front of the vane and behind it, suction (section A-A), 2nd row front side compression (section B-B), 3rd row rear side compression (section B-B). row rear side compaction (section C-C), 4th row rear side extension working stroke (section D-D), 5th row front side working stroke (section E-E), 6th row in front of the wing and behind it discharge (section F-F) and by rotating the control box by 30°, whereby four different operations such as suction, compaction, working stroke, discharge are achieved by opening or closing the openings.

8. Fully hybrid rotary engine (E2) according to claim 7 characterized in that cylinder core unit with intake-exhaust ducts 16 and easily replaceable cartridge 23, consisting of electric heating rod elements 27, injection nozzles for air and liquid 28, resilient sealing rings for replaceable cartridge complete 25, reaction cell carrier for 1 and 2 and sleeve with intake and exhaust ducts 18, cover with screws 17-20, end bearing 21, sealing and oil rings with anti-rotation lock 22, mounting cover for replaceable cartridge complete with screws and gasket 24, can be quickly replaced as a spare part.

9. Fully hybrid rotary motor (E1, E2) according to claim 1, characterized in that the jointly used hydrodynamic flow brake, which is preferably operated with water as hydraulic oil, against reverse rotation of the inner and outer rotors 1, 3 with drive shaft inputs 85, 86 on both sides, fixed housing and outer single-sided paddle wheels 111, 115 with immovable vanes and in a central double-sided fixed paddle wheel with immovable vanes 113, and in between are fixed double-sided paddle wheels with movable blades 112 and torsional vibration springs 134, 136, which provide for smooth transitions if required, at the outer and inner rotor shafts 85, 86, with water circulation limiting ribs 130, limiting plates 125 and openings 114, conduit ports 126 for heated fluid exchange through heat exchanger 56 for heat energy recovery on housing 110, heat insulation shells 127 against heat loss, using heated water for injection.

10. Full hybrid rotary engine (E1, E2) according to claim 1, characterized in that the power transmissions of outer and inner cylinder rotors are connected by extension shafts 84 with bearings 87, seals 88 such as toothed belt wheels 90-95, wide belts 100, belt tensioners 101, electric clutches for front with braking 97 and rear 99, for as drive and charging current generators 98 and optionally switchable high-pressure compressors 103, whereby hydrodynamic flow brake 110-135, flywheel 48, which is required for inner cylinder rotor 3 as mass compensation compared to outer cylinder rotor 1, and the wheels are driven by battery group with cooling 104, with rim 106, 106a or axle drive 108, -generators and the whole is regulated via electronic control box 107.

11. Full hybrid rotary motor (E1, E2) according to claim 10 as an alternative, characterized in that the power transmissions of the external and in the short version of the motor with a hydrodynamic flow brake with shaft inputs on both sides can be used individually or together, depending on the type of use, the speeds of the two shafts are matched, the toothed belt pulleys 91a may have to be identical in size with couplings, whereby the same applies to E1+E2 together in the case of the design with a stepper motor 140.

12. Fully hybrid rotary motor (E1, E2) according to claim 4, characterized in that the stepper motor stator 140 is coupled to the inner cylinder rotor 3 in a ratio of 1 to 1 by movement elements 63, 149, wherein the stepper motor rotor 141 cycles by 30° with a control element 107 consisting of discs 150, 152 with an angle encoder 151, which transmits the position of the two rotors by pulses and is thereby transmitted to the control sleeve 12 in the ratio 1 to 1 synchronously by movement elements 66-67 and thereby determines opening/closing times with opening duration.

13. Fully hybrid rotary motor (E1, E2) according to claim 4, characterized in that control sleeve 12 is equipped with the oil sealing rings 15, sealing strips 13, which are made from one piece in length for ease of assembly, with matching recesses at the ring points and, for tightness, with compression spring blades 14 of the same radius to match the cylinder diameter, whereby, for good lubrication, control sleeve 12 is equipped with the oil holes or channels 47 on the end faces and with heat-resistant oil seals 47 on the end faces. channels 47 and is connected to the central oil circuit by heat-resistant seals 47b.

14. Fully hybrid rotary motor (E1, E2) according to claim 3, characterized in that the pressure-side vane surfaces 4, 4.1, of inner and outer cylinder rotors are concave in order to achieve better air and gas exchange, respectively. gas exchange, whereby the lateral and cylinder-side surfaces are equipped with oil sealing strips 7-10, which are manufactured in the same cylinder radius for tightness and equipped with compression spring blades 14, whereby corner pieces 7a-10a with compression springs are installed at the edges to compensate for wear.

15. Full hybrid rotary engine (E1, E2) according to claim 1, characterized in that charging of the on-board battery by compressed air operation is possible in the parked state with a full air tank, whereby the supply is improved by additional compressed air base stations in the residential areas, whereby surplus energy can be filled into air tanks during the journey with E1 or E2 operation using the vehicle's own compressors, thus keeping battery capacity, weight and price low and avoiding time-consuming charging processes with expensive, inadequate service networks for electric vehicles.

16. Full hybrid rotary motor (E2), according to claim 1, characterized in that the type of construction offers a suitable prerequisite for the use of highly developed new materials such as sintered materials, including ceramic materials, whereby the friction is reduced to a minimum, while environmentally friendly lubricants are used by central oil pump 49, with external oil reservoir, filter 53.

17. Full hybrid rotary engine (E2), according to claim 2, characterized in that instead of compressed air injection, H2O or liquid CÖ2 or similar is injected as an alternative and is used by the vapour pressure, whereby after the warm air mixture is discharged through the cooler and filter system, the liquid is separated and kept at an optimum temperature separately by sensor assistance,

| H2O-lower limit: | Upper limit: | Difference | Gain |
|---|---|---|---|
| ° C./pressure | ° C./pressure | in ° C | in: |
| 200° C./16 bar | 370° C./210 bar | 170° C. | =190 bar/or |
| 120° C./2 bar | 370° C./210 bar | 250° C. | =208 bar |
| CO 2-lower limit: | Upper limit: | Difference | Gain |
| ° C./pressure | ° C./pressure | in ° C. | in bar |
| ~9° C./30 bar | 150° C./120 bar | 141° C. | =90 bar or |
| ~20° C./50 bar | 150° C./120 bar | 130° C. | =70 bar |

with CO2˜9°-20° C. and approx. 30-50 bar-liquid CO2 is passed on again in a closed circuit for spraying and the air portion is passed on to intake nozzle 55.
